(19) United States
(12) Patent Application Publication
(10) Pub. No.: US 2012/0308309 A1
(43) Pub. Date: Dec. 6, 2012

(54) MANUFACTURING METHOD, DRIVING IN AND INJECTION OF UNDERWATER PILES

(75) Inventor: Cesar Del Campo y Ruiz de Almondovar, Cadiz (ES)

(73) Assignee: Grupo De Ingenieria Oceanica S.L., Tenerife- Islas Canarias (ES)

(21) Appl. No.: 13/514,859

(22) PCT Filed: Dec. 10, 2010
(86) PCT No.: PCT/ES2010/000510

§ 371 Date: Aug. 10, 2012

(30) Foreign Application Priority Data
Dec. 11, 2009 (ES) P200902317

(51) Int. Cl. E02D 5/34; B23P 17/00; E02D 7/00

(52) U.S. Cl. 405/233; 405/232; 29/897.33

(57) ABSTRACT

Manufacturing, driving and injection method of underwater piles that serve as a foundation for any structure or platform in which one starts with a pillar or pipe (4) to which, during manufacturing, a pile (5) has been inserted in its interior. The methods solve all the possible cases, independently of whether the ground has little resistance or that the load is very great since there are several solutions that the system may adopt to solve all the problems, which are: pile driving on the ground, central injection and by bulb, peripheral injection and radial injection.

In addition it includes load tests and an embedding system of the pillar in the slab or structure that is going to support it.

### TECHNICAL FIELD

This invention is encompassed within the technical field of the construction of fixed structures in water, more specifically, to the methods of driving in and injecting the underwater piles for the holding of marine platforms or equivalents.

### BACKGROUND OF THE INVENTION

The execution of piles in the bottom of underwater areas presents greater difficulties than when done on land.

Normally it is solved with boats or floating devices especially designed for it, which hold vertical the pipe that is going to constitute the pile, supporting it on the bottom and they sequentially beat it with an appropriate heavy hammer until managing to drive it a certain depth into the bottom of the sea, so that the joint resistance to the driving of the point (pile shoe) and of friction of the shaft produces rejection, that is, that the pile cannot be driven in or it has been done for a determined depth with “n” number of blows with the hammer.

The solution is appropriate for driving in piles that must extend from the sea floor to a certain height above the water surface. It is expensive; it requires very specialised equipment and it poses problems of environmental impact that can be very serious. Another form of executing them is to place in the same way a vertical guide pipe, supporting it on the bottom and inserting in its interior a pipe that is going to be the final pile. Through the inside of this pipe a drill head and hoses are inserted for the injection of water. The drill goes removing the sediment and the water pressure raises it to the upper part of the guide pipe, from which they are conducted to deposits or, what is more common, it is dumped to the sea. The removal of sediments makes the pile be driven in up to the planned depth, at which time it is necessary to inject cement filler to fasten the pile to the ground. The carrying capacity of the pile can also be improved by making repeated and selective injections, both at the point as well as throughout the entire shaft. When the driving and injection are finished, the guide pipe is removed and a finished pile remains, extending above the level of the seabed.

So that this pile is useful, it is necessary to connect it to the structure that it has to support, making an underwater pile cap of concrete.

All these operations are very costly, complicated to execute, of quality that is difficult to ensure, produce negative environmental impacts and require very specialised equipment and proper climate conditions.

In short, there is the need to make a foundation of underwater piles, without environmental impact and at economically competitive prices.

### DESCRIPTION OF THE INVENTION

The method of driving in and injection of underwater piles that is subject of this invention which presents the form of solving the technical problems explained above.

In order to solve them, it is necessary to design a new type of pile and system for inserting the vertical structural elements, creating an integrated manufacturing procedure, inserting into the interior the vertical structural elements, driving it in, injection load testing and embedding it in the foundations in such a way that they are configured as mixed foundations of slabs and piles.

Starting with the elements already existing in the platforms or structures, a system has been developed that permits using them and avoiding the guide pipes and the contamination of the environment.

The elements to use are the vertical pipes or pillars existing in the vertices of the vertical structures that hold the platforms and that are intended to be fastened to the sea bottom with the foundation and even the wind-generating tower, if this is what is to be installed on the platform.

The method consists of inserting (with an automated procedure that will be described below in detail) during the manufacturing process on land the pillars or the pipes located on the vertices of the tower a specially designed pile within each of these pipes. Once the pile is in the interior of the pillar, the pipe is closed from above with a hermetic threaded cover, a ring seal is placed on the pile and on the ring seal a load-distributing cover.

Since it is interesting to recover the two covers for their reuse, a tie cable is placed between both elements that allows recovering them later.

The manufacturing of the piles is done on land, in an installation attached to that manufacturing the lattice structures, in whose vertical elements they are going to be inserted.

A series of containers of pipes for piles arrive at this attached installation as well as the following complementary pieces: steel mesh, fitting pipes in the pile cap, complete pile shoes and plugs for the peripheral injection through the shaft, that is, all the elements necessary for the manufacturing of the pile.

A bridge crane takes a pipe and places it on a turning gear. Parallel to the turning gear there are two guides, one on each side, on which a hydraulic punch head, provided with rectangular interchangeable punches, is supported. On the punch, there is a pillar, with a sliding plate on the guide, placed at 90° to the pillar. On the opposite end of the turning gear and fastened to the ground there is another identical punch head, with a pillar and fixed support of the horizontal guide. In the horizontal guide there is a set of vertical drills, all of them on sliding plates and equipped with motorised pinions, in order to move on the rack fixed to the guide.

The free punch head moves along the parallel guides, to adapt to the length of the pipe used as pile or for embedding in each case. Each of the punch heads located at each end of the pipe makes a slot. Simultaneously the drills, which automatically will have been placed in the established position, make a set of aligned holes.

The perforations and the punches having been made, the drills are raised and the punch head opens to permit the turning gear, on which the pipe is located, to turn at a certain angle. The operation of punching and drilling is repeated in the same way as many times as necessary.

When these operations have ended, the bridge crane removes the pipe and places it on a set of parallel dollies of variable height and some motorised dollies that serve to hold and move the pipe lengthwise.

The bridge crane takes a cylinder of prefabricated steel mesh that has a diameter less than the interior of the pipe and places it on the dollies of variable height; the height is adjusted and they move lengthwise until the mesh is totally inserted in the pile.

Then the service operator folds the vertical pieces of the mesh towards the exterior, along the punched slots.

The bridge crane takes another mesh cylinder and places it on the elevating dollies, their height is adjusted to permit the pile with the interior reinforcement already in place to be driven in the opposite direction by the motorised dollies that hold it and then inserts it in the interior of the exterior reinforcement.

The service operator folds the vertical parts of the mesh towards the interior, through the slots, the bridge crane removes the pile to a stockpiling or storage area and the service operator puts in place the pile shoe, the peripheral plugs for the injection of the shaft and the ring seal and the other pieces necessary for the driving and injection of the piles.

When the lattice structure that is manufactured in a parallel installation is prepared, the bridge crane places the finished piles on some dollies that drive them until they are inserted completely in the interior of the longitudinal pipes that form part of the lattice structure.

Once that the pipes have the piles inside, the pile-driving procedure is simple.

It starts with an auxiliary pump that takes the water to a tank. A main pump (with constant flow and pressure) sends water from this tank to a regulator. From the regulator the water comes out with variable pressure and flow. From this regulator come out as many hoses as there are piles to be driven simultaneously. This water hose is screwed above into the cover which in turn we have screwed onto the pillar. A water hose is connected to the hole for the water under pressure and water begins to enter the space that remains between the steel load-distributing cover and the ring seal. By increasing the pressure the seal is first compressed and its closure is improved and as the pressure increases the piles begin to be driven into the ground.

The pile has a pile shoe (cone of prefabricated concrete with rubber joint) which facilitates the driving. The pressure continues to increase and the pile continues going down, until the pressure that we have to exercise (water pressure) to fasten the pile multiplied by the surface area of the pile base is the load that is intended for the pile to withstand.

Since the resistance of the ground is different in each location, it will occur that piles are driven in at different depths, but all with the certainty of bearing the planned load. Therefore, this method of driving the piles has the advantage of the driving itself being a test of sufficient load that avoids having to oversize the foundation, so that they are driven in to the necessary and proper depth, reducing costs and without loss of safety. This methods is also of great importance for the scientific scope of calculating underwater piles since on land the pile calculation methods are based on thousands of experiences that lead to the rules; however, under water there is little experience and the doubt continues to exist of whether or not it is appropriate to apply the pile calculation methods used on land. Therefore, having proof of load capability in the sea means the certainty of applying the correct load and also of helping to know the calculation methods in the sea and knowing if it is or is not appropriate to apply the pile calculation methods on land.

In order to achieve the required resistance in the pile, it is necessary to embed it in the foundation. For this, a pipe has been placed in the foundation (with greater diameter than the pile, manufactured in the same way as described, that is, with notches for placing the exterior and interior reinforcements) before pouring the concrete. Upon pouring it and once it is set, the pipe will be solidly fastened to the foundation by its exterior reinforcements, with the interior reinforcements remaining for the union with the exterior of the pile with the injection of cement filler through the pipes. Placed peripherally to the pile and in the space existing inside the vertical pipe and the exterior of the pile, being solidly joined to the foundation.

Therefore, this pile-driving system presents a series of additional advantages such as permitting driving several piles simultaneously and it deals with a method that does not produce noise, pollution, turbidity of the water and has no impact on the sea.

The pile-driving system has just been presented, but it may occur that it does not always comply with the necessary requisites of light load and good soil where the support is sufficient with simply driving piles; on many occasions it is essential to inject the piles with cement filler, as explained below.

There are various types of injection, according to whether more or less resistance of the pile is required: central injection of the pile, to increase the structural blocking of the pipe, injection of bulb under the pile shoe, to increase the resistance of the point and peripheral injection and radial injection, to improve resistance through the shaft.

In order to carry out the central injection of the piles, the closing cover has a hole through which the concrete filler is injected.

In order to increase the structural blocking of the pipe, injecting in its interior, provided with steel reinforcements, is sufficient, as has been explained, and it will constitute a reinforced concrete and steel structure of greater structural blocking than that of the pipe and the objective will be achieved.

If it is necessary to increase even more the resistance of the pile, there are three alternatives: increasing the resistance of the shaft, of the point or both and the system claimed here solves all of them.

In order to increase the resistance of the shaft it is sufficient to begin to inject through a series of peripheral pipes cement filler from the start of the pile driving. The pile shoe, being of greater diameter than that of the pile, will go opening a perforation in the bottom of that diameter, the space up to the pile is simultaneously filled with cement filler, the pile will have exterior reinforcements throughout its length which will reinforce the filler and hold it firmly to the pipe; in this way the diameter of the pile is increased and consequently the lateral surface, and the friction coefficient will improve and consequently the resistance.

If it is necessary to increase even more the shaft resistance, one can turn to the injection system, at a point, radially and throughout the length of the shaft. To accomplish this, the system considers the realisation of lines of parallel drilled holes throughout the length of the shaft and separated from each other by a circumference arc of the necessary degrees. In the manufacturing process, a plug of hard elastomer material will have been inserted by pressure in each hole, to which a steel cable will have been joined on its base and on which opposite end is a hook that will be hooked to the interior reinforcement of the pile during manufacturing, with the entire cable remaining therefore inside the pile. By injecting filler cement inside the pipe, as is done to increase the structural blocking, first the interior of the pipe is filled and the pressure continues increasing until exceeding the pressure of inserting the plugs. The plugs, by exceeding the pressure at which they were inserted shoot out radially towards the ground, perforating it, dragging the cable joined to its base and opening a perforation that will be filled with filler cement reinforced by the cable and united to the interior reinforcement and therefore to the reinforced concrete of the interior of the pile. The system permits continuing to increase the amount of filler cement inside the pile and the pressure in order to provoke the exiting to the ground of more filler and therefore increasing the peripheral consolidation area.

As regards increasing the resistance of the point, two circumstances can occur: the first is that it is not necessary to carry out the radial injection and second, that it is. The system solves both cases in a reliable and easy way, based on the same system of plugs with programmed resistance. In this case the pile shoe has a plug with a diameter larger than that of the radial plugs of the shaft and therefore with greater resistance to exiting. With the central injecting being finished or in the high-pressure phase, the plug will shoot out towards the bottom, provoking the exiting of the cables, various in this case and forming a reinforced bulb of the dimension that is needed, according to whether more or less filler is injected. If it were the first case, that is, piles without radial injection, the system will function in the same way.

If the resistances of the shaft and point need to be increased, it is sufficient to successively carry out the described procedures.

The problem that is originated when the piles are injected is that it is not possible to know directly their load capacity since this depends on the resistances of materials that must harden.

In order to overcome this problem, some pipes are installed that project out above the pillar with a piston seal. Once the pile is injected and hardened a load traction and compression test is conducted with these pipes.

In order not to lose all the equipment and all the pipes, there is a threaded element, the traction cover, which is the element where in the end all the pipes are joined, in order to test the traction. Once the test is conducted, the pipes can be extracted, unscrewing the cover and taking the pipes out from the top. Thus, all the elements are recoverable. With this system the problem of joining the pile to the structure that has to support it is also solved, making an underwater pile cap of concrete simultaneously with the driving and the injection.

Therefore, and as has been seen above, there are several solutions to which the system adapts to solve the problems of the state of the technique:
1. Pile driving done on land. It allows direct load testing of each pile driving.
2. Central injection and by the bulb. The structural blocking of the piles is improved and the driving resistance is reinforced, by point. It does not allow testing the direct load of each pile driving.
3. The peripheral injection that allows obtaining a pile of much greater diameter, concreting the space that remains between the pipe and the pile.
4. The radial injection throughout the entire length of the pile shaft. It has a device to conduct a load test once the concrete is set.

In all the cases, the embedding system of the pillar in the slab or structure is the same (embedded pipe with reinforcement).

Using one method or another depends on the relation between the resistance of the ground and the load that is going to be applied, as well as the seismic activity existing in the installation's location.

For this reason this system is good and necessary, capable of adapting to any situation.

### DESCRIPTION OF THE FIGURES

In order to complete the description that is being made and for the purpose of aiding a better understanding of the characteristics of the invention, a set of drawings are attached where the features are provided as an illustration but are not limited to the following:

FIG. 1: Breakdown of the upper part of the pipe

FIG. 2: Plan view of the upper closing cover

FIG. 3: Plan view of the load distribution cover

FIG. 4: Plan view of the ring seal

FIG. 5: Diagram of blocks of the pile-driving process

FIG. 6: Diagram of blocks of the pile-injecting process

FIG. 7: Elevation and plan of the central part of the pipe

FIG. 8: Elevation and plan of the pipe reinforcements

FIG. 9: Elevation of the reinforcements of the pile and pile shoe

Below is a list with the references used in the figures:
(1) Upper closing cover of the pipe
(1′) Recovery cable
(2) Load distribution cover
(3) Ring seal
(4) Vertical pipe of the pillar
(5) Pile
(6) Valves (holes)
(7) Passing pipes for peripheral injection
(8) Auxiliary guide cover
(9) Pipes for traction tests
(10) Secondary waterproof cover
(11) Pipe for central injection
(12) Principal cover with ring seal, for driving by hydraulic pressure
(13) Ring seals
(14) Pile or Pipe for embedding in the foundation with its embedding reinforcement
(15) Pile reinforcement
(16) Exterior reinforcement of embedding of the pipe of the pile cap
(17) Interior reinforcing of embedding of the pipe of the pile cap
(18) Space for concreting of the embedding
(19) Pile shoe
(20) Pile shoe plug

### DETAILED DESCRIPTION OF THE INVENTION

To achieve a better understanding of the invention, the manufacturing, injection and driving method of the underwater piles that is claimed herein will be described below.

As observed in FIG. 1, starting with a pillar or pipe (4) to which, during manufacturing, a pile (5) has been placed in its interior. The pipe (4) is closed above with a threaded hermetic cover (1). A ring seal (3) is placed on the pile and a load distribution cover (2) on the ring seal (3). In order to recover these covers (1, 2) a tie cable or recovery cable is installed (1′).

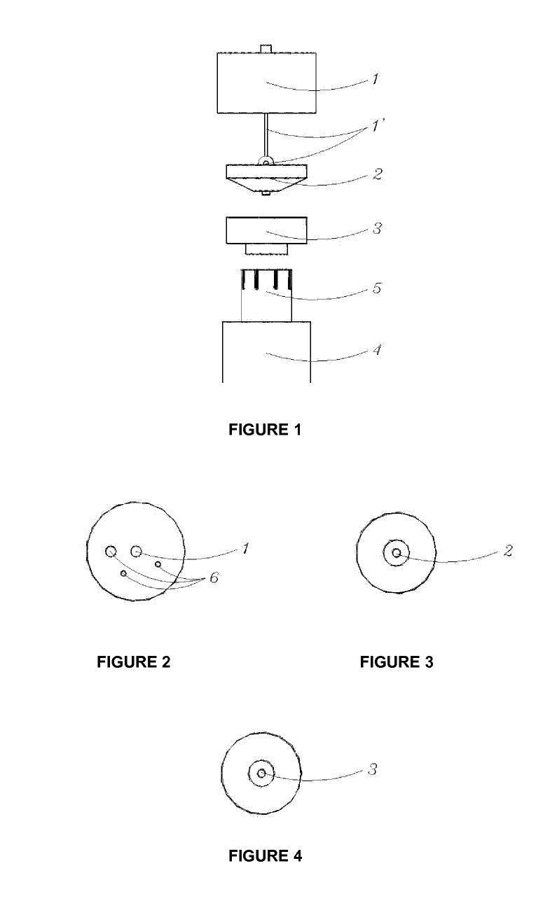

As observed in FIG. 2, the threaded hermetic cover (1) has a series of holes (6) for the insertion of pipes and valves, as will be explained later.

In FIG. 3 the plan view is observed of the load distribution cover (2) with a hole in the centre, like that of the ring seal (3, FIG. 4) whose use will be explained later.

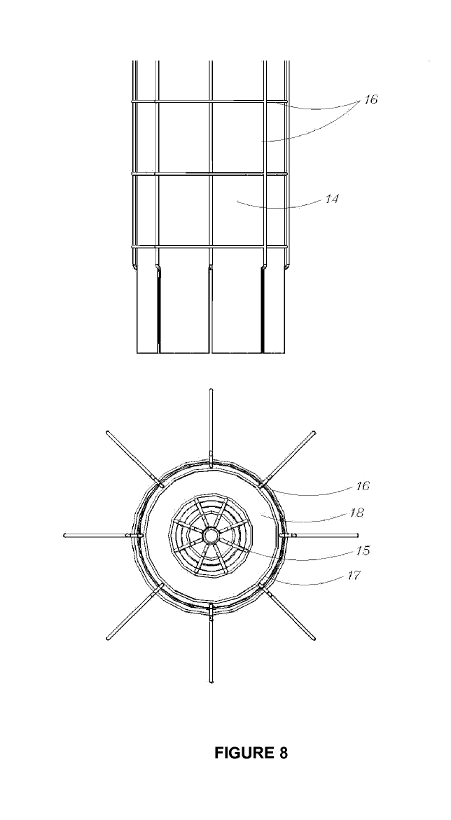

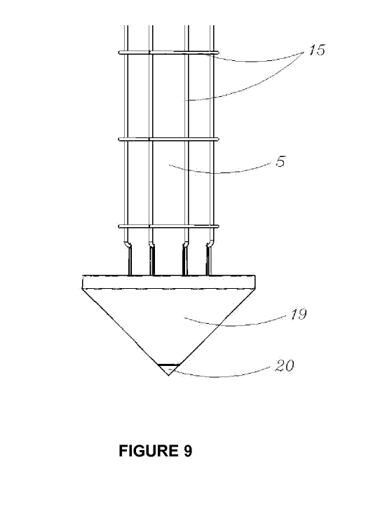

Before beginning to detail the pile-driving process (5), their manufacturing procedure and their insertion inside the pipe (4) will be described (See FIGS. 8 and 9).

The pile (5) manufacturing process is done on land, in an installation attached to that of the manufacturing of the lattice structures, in whose vertical elements or pipes (4) the piles (5) are going to be inserted, once manufactured.

A series of containers of pipes for piles (5) will arrive at this installation annex as well as the following complementary pieces: steel mesh (15, 16, 17), pipes for embedding in the pile cap, complete pile shoes (19, 20) and plugs for the peripheral injection through the shaft, that is, all the elements necessary for the manufacturing of the pile (5). The pile (5) manufacturing process is the following:
A bridge crane takes a pipe (5) and places it on a turning gear. Parallel to the turning gear there are two guides, one on each side, on which a hydraulic punch head, provided with rectangular interchangeable punches, is supported. On the punch, there is a pillar, with a sliding plate on the guide, placed at 90° to the pillar. On the opposite end of the turning gear and fastened to the ground there is another identical punch head, with a pillar and fixed support of the horizontal guide. In the horizontal guide there is a set of vertical drills, all of them on sliding plates and equipped with motorised pinions, in order to move on the rack fixed to the guide
The free punch head moves along the parallel guides, to adapt to the length of the pipe used as the pile (4) or for embedding in each case. Each of the punch heads located at each end of the pipe make a slot.
Simultaneously the drills, which automatically will have been placed in the established position, made a set of aligned holes.
Once the perforations and the punches have been made, the drills are raised and the punch head opens to permit the turning gear, on which the pipe is located, to turn to a certain angle. The operation of punching and drilling is repeated in the same way as many times as necessary.
The operation of punching and drilling is repeated in the same way as many times as necessary.
When these operations have ended, the bridge crane removes the pipe (5) and places it on a set of parallel dollies of variable height and some motorised dollies that serve to hold and move the pipe lengthwise.
The bridge crane takes a cylinder of prefabricated steel mesh (15) that has a diameter less than that of the interior of the pipe (5) and places it on the dollies of variable height; the height is adjusted and they move lengthwise until the mesh (15) is fully inserted in the pile (5).
Then the service operator folds the vertical pieces of the mesh towards the exterior, (15) along the punched slots
The bridge crane takes another mesh cylinder (16) and places it on the elevating dollies; their height is adjusted to permit the pile with the interior reinforcement already in place to be driven in the opposite direction by the motorised dollies that hold it and then inserts it in the interior of the exterior reinforcement.
The service operator folds the vertical parts of the mesh towards the interior, through the slots.
The bridge crane removes the pile to a stockpiling or storage area and the service operator puts in place the pile shoe (19, 20), the peripheral plugs for the injection of the shaft and the ring seal and the other pieces necessary for the driving and injection of the piles (5).
When the lattice structure that is manufactured in a parallel installation is prepared, the bridge crane places the finished piles (5) on some dollies that drive them until they are fully inserted in the interior of the longitudinal pipes (4) that form part of the lattice structure.

Once the pipes (4) with the piles (5) inside are in the place for the driving or definitive placement, the pile-driving process begins of the pile into the ground.

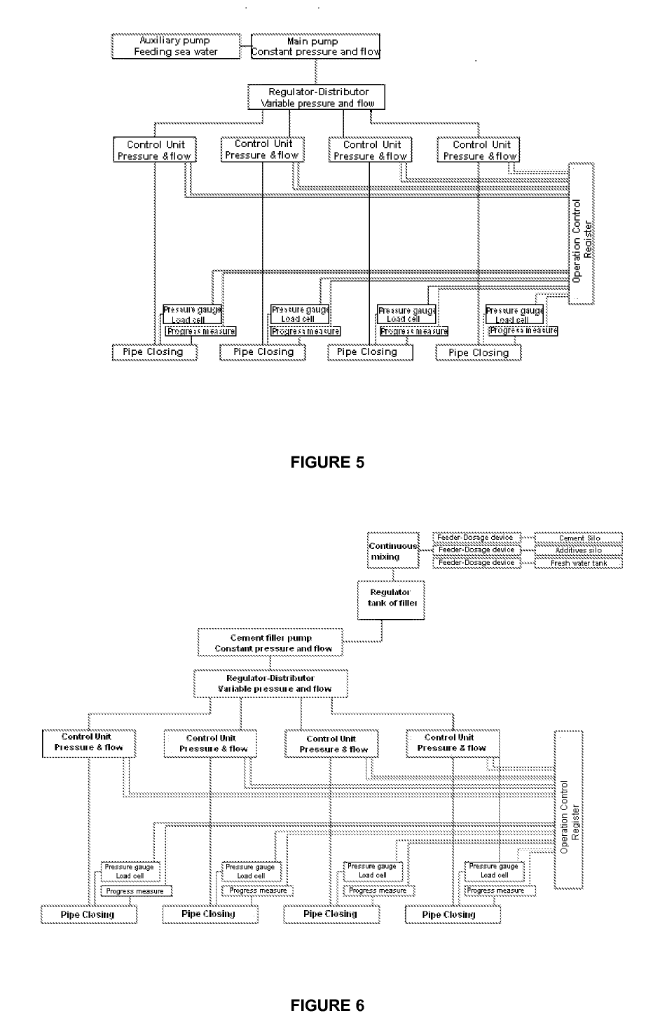

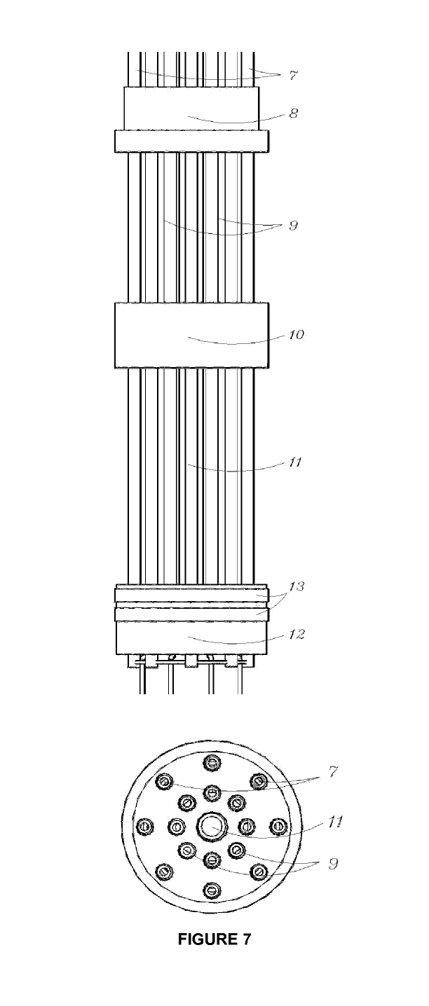

For a better understanding of the procedure, a chart is attached in FIG. 5 that clarifies the process (although the chart refers to sea water, the process is used indistinctly for fresh water).

It starts with an auxiliary pump that takes the water to a tank. A main pump (with constant flow and pressure) sends water from this tank to a regulator, since the pile driving requires variable pressure and flow. Since the pump has only one outlet and the simultaneous driving of several piles is intended, then from this regulator come as many hoses or feeding pipes as there are piles to be driven simultaneously. Each feeding pipe to the pile will have a control unit and pressure and flow regulation. The water pipe that feeds each pile is screwed above, into the cover (1) which in turn we have screwed onto the pillar (4). Then water begins to be introduced in the space that remains between the steel load-distributing cover (2) and the ring seal (3). By increasing the pressure the first thing that happens is that the seal (3) is compressed and its closure is improved and as the pressure increases the piles (5) begin to be driven into the ground.

The regulator allows adjusting the pressure and flow to that programmed automatically by the process control and distribute it to all the piles (5).

So that the pile (5) can be driven, it has a pile shoe (cone of prefabricated concrete with rubber joint) underneath which facilitates the driving.

The pressure continues to increase and the pile (5) continues going down. Each control and regulation unit will send data to the central unit. In the closing cover (1) of each pipe (4) can be installed load cells or pressure gauges to determine the actual pressure in the inside of the pipe (4) and precision flowmeters or measurements of displacement in order to determine the progress of the pile (5). Different equipment will transmit their data to the central unit.

The purpose of the central unit of operation and registration is to direct, control and record all the parameters of the driving processes. Water continues to be introduced until the pressure that we have to exercise (water pressure) to fasten the pile (5) multiplied by the surface area of the pile (5) base is the load that is intended for the pile (5) to withstand (it is the load test).

The operation and registration central unit allows stopping the driving of one pile (5) and the remainder continuing, since the depth to which each one is driven will depend on the type of ground on which it is supported, but all will end their driving with the certainty of withstanding the planned load.

In order for the pile (5) to attain the required resistance, it is necessary to embed it in the foundation (not shown). To do this, a pipe (of a diameter greater than that of the pile, manufactured in the same way as described, that is, with notches for the placement of exterior and interior reinforcements) will have been placed in the foundation (which could be a concrete slab) before pouring the concrete. Upon pouring it and once it is set, the pipe will be solidly fastened to the foundation by its exterior reinforcements, with the interior reinforcements remaining for the union with the exterior reinforcements of the pile (15) with the injection of the cement filler, remaining solidly united to the foundation.

As regards the pile injection process, as explained in the description, there are different injection phases according to the additional resistance that is required for the pile.

A first phase would correspond to carrying out the central injection of the pile and of the bulb. If more resistance is required, then peripheral and radial injection is carried out. FIG. 6 shows the chart of the injection process. It is observed that the process is the same as that of driving but in this case injecting cement filler instead of water. In the injection process the flow and the pressure of injection can be varied independently.

In order to carry out the central injection of the piles, the closing cover (1) has a hole with a pipe (11) through which the cement filler is injected.

In order to increase the structural blocking of the pipe (4) it is sufficient to inject concrete in its interior which is provided with steel reinforcements (16, 17), as stated previously, constituting a reinforced concrete and steel structure with greater structural blocking than that of the pipe (4) and achieving the objective.

If it is necessary to increase the resistance of the pile (5), three alternatives are possible: increasing the resistance of the shaft, of the point or both, and all are solved with the system claimed herein.

In order to increase the resistance of the shaft it is sufficient to start to inject cement filler through a series of peripheral pipes (7) from the beginning of the pile driving. The pile shoe (19), being of greater diameter than that pile (5), will go opening a perforation in the bottom the size of its diameter, the space up to the pile (5) is filled simultaneously with cement filler, the pile (5) will have exterior reinforcements (15) throughout its length which will reinforce the filler and hold it firmly to the pipe (4), in this way the diameter of the pile (5) is increased and consequently the lateral surface and the friction coefficient will improve and consequently the resistance.

If it is necessary to increase even more the shaft resistance, one can turn to the injection system, at a point, radially and throughout the length of the shaft. For it, the system considers the realisation of lines of parallel drilled holes throughout the length of the shaft and separated from each other by a circumference arc of the necessary degrees. In the manufacturing process, a plug of hard elastomer material will have been inserted by pressure in each hole, to which a steel cable will have been joined in its base in whose opposite end is a hook that will be hooked to the interior reinforcement of the pile during manufacturing, with the entire cable remaining therefore inside the pile. Injecting filler cement inside the pipe, as is done to increase the structural blocking, first the interior of the pipe (4) is filled and the pressure continues increasing until exceeding the pressure of insertion of the plugs. The plugs, with the pressure exceeding that at which they were inserted, with shoot out radially towards the ground, perforating it, dragging the cable joined to its base and opening a perforation that will be filled with filler cement reinforced by the cable and united to the interior reinforcement and therefore to the reinforced concrete of the interior of the pile (5). The system permits continuing to increase the amount of filler cement inside the pile (5) and the pressure in order to provoke the exiting to the ground of more filler and therefore increasing the peripheral consolidation area.

As regards increasing the resistance of the point, the pile shoe (19) has a plug (20) with a diameter larger than the radial plugs of the shaft and therefore with greater resistance to exiting. With the central injecting being finished or in the high-pressure phase, the plug (20) will shoot out towards the bottom, provoking the exiting of the cables, various in this case and forming a reinforced bulb, of the dimension that is needed according to whether more or less filler is injected.

If the resistances of the shaft and point are needed to be increased, it is sufficient to successively carry out the described procedures.

The problem that is originated when the piles (5) are injected is that it is not possible to know directly its load capacity since this depends on the resistances of materials that must harden.

In order to overcome this problem, some pipes (9) are installed that project out above the pillar with a piston seal. Once the pile (5) is injected and set with these pipes a load test is conducted with traction and compression.

In order not to lose all the equipment and all the pipes, there is a threaded element, the traction cover, which is the element where in the end all the pipes are joined, in order to test the traction. Once the test is conducted, the pipes (9) can be extracted, unscrewing the cover and taking the pipes (9) out from the top. Thus, all the elements are recoverable.

Therefore, with this manufacturing, pile driving and injection system of underwater piles, all the possible cases are solved, independently of whether the ground has little resistance or that the load is very great.

1. Manufacturing method of underwater piles that serve as foundation for any structure or platform, independently of the type of ground in which they are going to be installed and the type of loads they are going to support, characterised by including the following stages:
A bridge crane takes a pipe (5) and places it on a turning gear. Parallel to the turning gear there are two guides, one on each side, on which a hydraulic punch head, provided with rectangular interchangeable punches, is supported. On the punch, there is a pillar, with a sliding plate on a guide, placed at 90° to the pillar. On the opposite end of the turning gear and fastened to the ground there is another identical punch head, with a pillar and fixed support of the horizontal guide. In the horizontal guide there is a set of vertical drills, all of them on sliding plates and equipped with motorised pinions, in order to move on the rack fixed to the guide.
The free punch head moves along the parallel guides, to adapt to the length of the pipe used as pile (4) or embedding in each case. Each of the punch heads located at each end of the pipe makes a slot.
Simultaneously the drills, which automatically will have been placed in the established position, made a set of aligned holes.
The perforations and the punches having been made, the drills are raised and the punch head opens to permit the turning gear, on which the pipe is located, to turn at a certain angle.
The operation of punching and drilling is repeated in the same way as many times as necessary.
When these operations have ended, the bridge crane removes the pipe (5) and places it on a set of parallel dollies of variable height and some motorised dollies that serve to hold and move the pipe lengthwise.
The bridge crane takes a cylinder of prefabricated steel mesh (15) that has a diameter less than the interior of the pipe (5) and places it on the dollies of variable height; the height is adjusted and they move lengthwise until the mesh (15) is fully inserted in the pile (5).
Then the service operator folds the vertical pieces of the mesh (15) along the punched slots.
The bridge crane takes another mesh cylinder (16) and places it on the raising dollies, their height is adjusted to permit the pile with the interior reinforcement already in place to be driven in the opposite direction by the motorised dollies that hold it and then inserts them in the interior of the exterior reinforcement.
The service operator folds the vertical parts of the mesh through the slots.
The bridge crane removes the pile to a stockpiling or storage area and the service personnel places the pile shoe (19, 20), the peripheral plugs for the injection of the shaft and the ring seal (3) and the other pieces necessary for the driving and injection of the piles (5).
When the lattice structure that is manufactured in a parallel installation is prepared, the bridge crane places the finished piles (5) on some dollies that drive them until they are inserted completely in the interior of the longitudinal pipes (4) that form part of the lattice structure.

2. Driving method of underwater piles that are manufactured following the procedure of the first claim, characterised by starting from a pipe (4) that has the pile (5) inside it and comprised of the following operations:
An auxiliary pump take water to a tank;
a principal pump (of constant flow and pressure) sends water from this tank to a regulator;
water under pressure and variable flow comes from the regulator through as many feeding pipes as there are piles to be driven simultaneously and in each feeding pipe to the pile there is a control and regulator for pressure and flow;
water begins to enter the pile (5) in the space that remains between the load-distributing cover (2) and the ring seal (3), first compressing the seal (3) and then, by continuing to increase the pressure, the piles (5) begin to be driven into the ground; so that the pile (5) can be driven, it has a pile shoe (19) (prefabricated concrete cone with rubber joint) underneath which facilitates the driving;
the pressure continues to increase and the pile (5) continues going down, while each control and regulation unit sends data on the actual pressure inside the pipe and on the advancing of the pile to the central unit;
water continues to be introduced until the pressure that must be exercised to fasten the pile (5) multiplied by the surface area of the pile (5) results in the load that is intended for the pile (5) to withstand (it is the load test).

3. Injection method of manufactured and driven piles as described in the previous claims, characterised by, in order to increase the structural blocking of the pipe (4), the concrete being injected in its interior which is provided with steel reinforcement (16, 17), constituting a reinforced concrete and steel structure of greater structural blocking than that of the pipe (4).

4. Injection method of manufactured and driven piles according to claim 3, characterised by, in order to increase the resistance of the shaft, it being sufficient to inject filler through the peripheral pipes (7) from the start of the driving in such a way that the pile shoe (19), being of greater diameter than that of the pile (5), will go opening a perforation of that diameter in the ground and the space up to the pile (5) will be filled with cement filler, the pile (5) will have exterior reinforcements (15) throughout its length, which will reinforce the filler and hold it firmly to the pipe (4), thus increasing the diameter of the pile (5) and consequently the lateral surface, and the friction coefficient will improve and consequently the resistance.

5. Injection method of manufactured and driven piles according to claim 4, characterised by, in order to increase even more the resistance of the shaft, carrying out the injection at a point, radially and throughout the length of the shaft, making lines of parallel drilled holes throughout the length of the shaft and separated from each other by a circumference arc of the necessary degrees, having inserted under pressure in each hole a plug of hard elastomer material, to which will have been joined in its base a steel cable in which opposite end is a hook that will be hooked to the interior reinforcement of the pile during manufacturing, with the entire cable remaining therefore inside the pile, so that by injecting filler cement inside the pipe (4) and by exceeding the pressure of insertion of the plugs they shoot out radially towards the ground, perforating it, dragging the cable joined to its base and opening a perforation that will be filled with filler cement reinforced by the cable and united to the interior reinforcement and therefore to the reinforced concrete of the interior of the pile (5).

6. Injection method of manufactured and driven piles according to claim 5, characterised by, in order to increase the resistance of the point, the pile shoe (19) having a plug (20) that by increasing the pressure of the radial injection, the plug (20) will shoot towards the bottom, causing the exiting of the cables, several in this case and forming a reinforced bulb, of the dimension that is required according to whether more or less filler is injected.

7. Injection method of manufactured and driven piles according to claim 6, characterised by, in order to know their load capacity, installing pipes (9) that project out over the pillar with a piston ring and once the pile (5) is injected and set, with these pipes a traction and compression load test is conducted.

8. Injection method of manufactured and driven piles according to claim 7, characterised by, in order not to lose all the equipment and all the pipes (9), there is a threaded element, the traction cover, that is the element where all the pipes are joined in the end, in order to make a traction test and once the test is done the pipes (9) can be extracted by unscrewing the cover and taking the pipes (9) out from the top.
